(19) United States
(12) Patent Application Publication
(10) Pub. No.: US 2011/0111097 A1
(43) Pub. Date: May 12, 2011

(54) EMULSIFIED FOOD PRODUCT

(75) Inventor: David MOBLEY, Gibsonia, PA (US)

(73) Assignee: H.J. HEINZ COMPANY, Pittsburgh, PA (US)

(21) Appl. No.: 12/900,838

(22) Filed: Oct. 8, 2010

Related U.S. Application Data
(60) Provisional application No. 61/250,189, filed on Oct. 9, 2009.

(51) Int. Cl. A23L 1/0522; A23L 1/39; A23L 1/24

(52) U.S. Cl. 426/62

(57) ABSTRACT

A food product includes about 0.1% to about 5.5% enzyme modified egg yolk, about 0.1% to about 5.0% modified starch, about 0.1% to about 0.6% acid balancing flavor component, water, a sweetener, and about 30 to about 45% vegetable oil. The acid balancing flavor component may include yeast and/or sugar.

### CROSS-REFERENCE TO RELATED APPLICATION

This application is entitled to priority of U.S. Provisional Patent Application Ser. No. 61/250,189, filed Oct. 9, 2009, the entire contents of which are incorporated herein by this reference thereto.

### BACKGROUND

This specification generally concerns an emulsified food product, such as a dressing, sauce, spread, or dip, and methods of making the emulsified food product. More particularly, this specification deals with emulsified food products including enzyme modified egg yolk, modified starch, corn syrup, and acid balancing flavor components.

The prior art discloses dressings, sauces, and dips. For example, U.S. Pat. No. 5,028,447, the entire content of which is incorporated by reference thereto, describes preservative free oil-in-water emulsions including enzyme modified egg yolk and native starches formed by gelatinizing the native starch, incorporating the enzyme modified egg yolk, incorporating oil and homogenizing the mixture. U.S. Pat. No. 6,231,913 discloses oil-in-water emulsion food product dressings including a suspending agent, a dairy product, an edible acid, water, unmodified egg yolk, sugar, salt and spices. U.S. Patent Application Publication No. 2007/0128325 discloses reduced oil dressing compositions including soybean oil, enzyme modified egg yolk, modified starches, but excludes corn syrup.

It has been found that an emulsified food product having superior stability can be formed having a unique formulation including enzyme modified egg yolk, modified starch, corn syrup, and at least one acid balancing flavor component.

### SUMMARY OF SELECTED ASPECTS OF THE INVENTION

An emulsified food product, such as a dressing, sauce, spread, or dip and methods of making the emulsified food product are described herein. The emulsified food product includes modified egg yolk, specialized starch, corn syrup, and at least one acid balancing flavor component.

A preferred emulsified food product comprises about 0.1% to about 5.5% enzyme modified egg yolk, about 0.1% to about 5.0% modified starch, about 0.1% to about 0.6% acid balancing flavor component, and corn syrup. The acid balancing flavor component includes yeast. Preferably, the yeast is a torula yeast. The emulsified food product may also include vegetable oil in an amount of about 30% to about 45% by weight based on the weight of the emulsified food product. Preferably, the vegetable oil is soybean oil. The emulsified food product preferably has a pH of about 2.8 to about 4.1.

In one embodiment, the emulsified food product can also include an additive selected from the group consisting of spices, herbs, vegetables, proteins, flavors, colors, preservatives, and combinations thereof. The emulsified food product can also include at least one dairy product. In the preferred embodiment, the at least one dairy product is buttermilk. The modified starch may be an instant, cold-water swelling starch. The product may also include water in an amount of about 30% to about 45% by weight based on the weight of the emulsified food product. The emulsified food product can also include at least one edible acid.

In the most preferred embodiment, emulsified food product includes about 36% water, about 3.5% dairy product, about 4.2% edible acid, about 40% soybean oil, about 1.1% modified starch, about 1.9% enzyme modified egg yolk, about 1.9% salted egg yolk, about 0.6% acid balancing flavor component, about 2.5% sugar, about 1.6% salt, about 0.6% monosodium glutamate, about 0.3% preservatives, about 4.8% corn syrup, and about 1% herbs, spices, and/or flavorants.

Preferably, the fat content of the emulsified food product is reduced by at least about 10% as compared to a conventional emulsified food product, more preferably by at least about 20%.

A method of making a emulsified food product comprises combining about 0.1% to about 5.5% enzyme modified egg yolk, about 0.1% to about 5.0% modified starch, about 0.1% to about 0.6% acid balancing flavor component, and corn syrup with water and oil. The acid balancing flavor component includes yeast. The method can also include adding preservatives, acid balancing flavor components, edible acids, sources of soluble fiber, and optional additives to the mixture while mixing. In the preferred embodiment, the method includes combining oil and gum in a separate container and adding the oil and gum to the mixture while mixing.

### BRIEF DESCRIPTION OF THE DRAWINGS

Many objects and advantages of the present invention will be apparent to those skilled in the art when this specification is read in conjunction with the drawings wherein:

FIG. 1 illustrates process steps for manufacturing an emulsified food product; and

FIG. 2 illustrates the texture and mouthfeel attributes for the emulsified food product of this specification and a known commercial product having a high oil content.

### DETAILED DESCRIPTION

An emulsified food product, such as a dressing, sauce, spread, or dip includes at least one enzyme modified egg yolk, at least one specialized starch, at least one acid balancing flavor component, and corn syrup.

Oil is both expensive and high in calories. Thus, by reducing the oil content of a dressing, sauce, spread, or dip, one can reduce both the cost and the caloric content in the resulting dressing, sauce, spread, or dip. However, oil provides an emulsified food product with creamy mouth feel, a full bodied texture, and microbiological stability by reducing water activity. In addition, oil effectively balances acidic bitterness of the dressing, sauce, spread, or dip. It has been found, that the amount of oil used in the emulsified product can be reduced without negatively affecting the mouth feel, texture, water activity, and flavor of the resulting emulsified product by including a unique combination of ingredients including enzyme modified egg yolk, modified starch, corn syrup, and at least one acid balancing flavor component.

As used herein, the term “modified starch” refers to instant starches, cold-water swellable starches, and the like including, without limitation, UltraSperse M®, UltraSperse SR®, and Textra Plus® available from National Starch, LLC.

As used herein, the term “enzyme modified egg yolk” refers to egg yolks treated with enzymes so as to modify the egg yolk to increase the emulsifying capacity of the egg yolk.

In the preferred embodiment, the emulsified food product includes water, oil, enzyme modified egg yolk, modified starch, a dairy product, at least one source of soluble solids or soluble fiber, at least one edible acid, at least one acid balancing flavor component, at least one gum, and optionally additional additives.

Preferably, water is included in the emulsified product in an amount ranging from about 20% to about 45% by weight based on the weight of the emulsified food product, more preferably about 25% to about 45%, and most preferably by about 30% to about 40%. Also preferably, the water is potable. Preferably, the water is chilled to less than about 80° F. before mixing with or incorporating it into other ingredients.

In the preferred embodiment, the emulsified product uses vegetable oil as the oil component. Other oils for use in the emulsified food product include, without limitation, soybean oil, corn oil, peanut oil, sunflower oil, sesame oil, coconut oil, palm oil, olive oil, safflower oil, cottonseed oil, canola oil, safflower oil, lard oil, fish oil, castor oil, and combinations thereof. In the preferred embodiment, soybean oil is used as the vegetable oil. Preferably, the oil included in the emulsified food product is present in an amount ranging from about 30% to about 45% by weight based on the weight of the emulsified food product, and more preferably in the range from about 35% to about 45%.

The emulsified food product also includes enzyme modified egg yolk. Suitable enzyme modified egg yolk includes those described in U.S. Pat. No. 5,028,447, the entire content of which is incorporated by reference thereto.

Suitable modified egg yolks include those modified with phospholipase A. In the preferred embodiment, Emulsa™ available from Michael Foods may be used as the enzyme modified egg yolk. Emulsa™ is an egg product mix intended for use in emulsions, and is modified with phospholipase. Phospholipases are a family of enzymes which hydrolyze carboxylic ester bonds within phospholipids. The treatment of phospholipids with enzymes, such as phospholipase, results in emulsions having superior stability, and in particular superior heat stability.

In the preferred embodiment, the enzyme modified egg yolk is included in the emulsified food product in an amount ranging from about 0.1% to about 5% by weight based on the weight of the emulsified food product, more preferably about 0.1% to about 4.5%, even more preferably about 1% to about 3.5%, and most preferably about 2% to about 3%. The enzyme modified egg yolk is included in an amount of at least about 0.1% to avoid creating a very thin and runny food product that would require additional thickening agents. The enzyme modified egg yolk is not included in an amount greater than about 5% so as to avoid forming an emulsified food product that is too thick. In addition, the use of higher amounts of the enzyme modified egg yolk increases the cost of the food product. In the preferred embodiment, the emulsified food product includes the enzyme modified egg yolk in an amount of about 2% by weight based on the weight of the emulsified food product. When oil is reduced in the emulsified product, viscosity of the product also decreases making it unsatisfactorily runny. By adding enzyme modified egg yolk, the product viscosity increases giving enhanced organoleptic characteristics of the product.

The emulsified food product can also include unmodified egg yolk in an amount of about 0.1% to about 2% by weight based on the weight of the emulsified food product.

In a preferred embodiment, the emulsified food product may also include at least one dairy product. Suitable dairy products include, without limitation, fresh or dehydrated buttermilk, skim buttermilk, whole milk, 2% milk, 1% milk, skim milk, and combinations thereof. Preferably, the dairy product is included in the emulsified food product in an amount ranging from about 1% to about 6% by weight based on the weight of the emulsified food product, preferably about 2.5% to about 5.5%, more preferably about 3.0% to about 5.0%, and most preferably about 3.5% to about 4.5%. The dairy product is only included in a food product that is typically made with a dairy component, such as, without limitation, ranch dressing, tartar sauce, and the like.

The emulsified food product also preferably includes at least one modified starch in an amount ranging from about 0.1% to about 5%, more preferably about 1% to about 4%, and most preferably about 2% to about 3%. Smaller amounts of the modified starch are not used to avoid the formation of a runny, thin food product. The modified starch may be a cold-water-swelling starch derived from waxy maize, or a cold-water-soluble starch derived from tapioca. Preferably, the modified starch also exhibits cold temperature storage stability. Preferred modified starches are selected from the group consisting of Ultrasperse M®, UltraSperse SR®, Textra® Plus, and combinations thereof. These preferred modified starches are available from National Starch. Bridgewater, N.J. The modified starch functions as a thickening agent to enhance the viscosity of the emulsified food product. Suitable modified starches can also be obtained from Tate and Lyle, Cargill, Roquette, and other manufacturers of specialty modified starches.

The emulsified food product may also include at least one source of soluble solids. In the preferred embodiment, the source of soluble solids is corn syrup. The source of soluble solids may be selected from the group consisting of a sweetener, high fructose corn syrup, light corn syrup, dark corn syrup, and combinations thereof. However, other natural or synthetic source of soluble fiber, including table sugar (sucrose), maltodextrins, a corn sweetener, other sweeteners, fiber sources, and/or artificial sweeteners can be used alone and/or in combination with the corn syrup. The corn syrup may be included in an amount ranging from about 2.0% to about 25.0% by weight based on the weight of the emulsified food product, preferably about 3.5% to about 20.0%, more preferably about 4.0% to about 15.0%, even more preferably about 4.5% to about 10.0%, and most preferably about 5.0% to about 8.0%.

Not wishing to be bound by theory, it is believed that the corn syrup helps balance the sweet and sour flavors of the emulsified food product formed herein. In addition, it is believed that the incorporation of corn syrup in an amount of at least 2.0% results in improved micro-stability. The primary purpose for addition of corn syrup and/or other sources of soluble solids or soluble fiber is to provide a consistency to the overall formula so as to reduce the overall amount of water contained in the emulsified food product. By reducing the amount of water, the microbiological stability is increased. The corn syrup and/or other sources of fiber also act as a bulking agent to reduce the amount of water in the formula. However, use of corn syrup in an amount exceeding about 25% may negatively affect the texture, flavor, and cost of the emulsified food product. Many other alternative solid materials may be included.

In the preferred embodiment, the emulsified food product includes at least one acid balancing flavor component in an amount ranging from about 0.1% to about 0.6% by weight based on the weight of the emulsified food product. The acid balancing flavor component functions to mask the typically acidic flavor of the food product. However, using the acid balancing flavor component in an amount great than about 0.6% results in an emulsified food product having an off-flavor as compared to a conventional emulsified food product. In the preferred embodiment, the acid balancing flavor component may be yeast, such as Provesta 600®, which is a torula yeast available from Ohly. Sugar can be included as an acid balancing flavor component in an amount ranging from about 1% to about 10% by weight based on the weight of the emulsified food product. Using too much sugar can raise the cost of production of the emulsified food product, increase the calories in the emulsified food product, and/or make the emulsified food product too sweet.

Also in the preferred embodiment, at least one edible acid is added to the emulsified food product to adjust the pH of the emulsified food product to about 2.8 to about 4.1, preferably about 2.9 to about 3.6, more preferably about 3.0 to about 3.5, and most preferably about 3.1 to about 3.4. This pH control adds flavor and/or reduces the acid bite of the emulsified food product. Preferred edible acids are selected from the group consisting of vinegar, phosphoric acid, lactic acid, and combinations thereof. In the preferred embodiment, the emulsified food product includes a combination of 120 grain vinegar, phosphoric acid, and lactic acid. Preferably, the vinegar is included in an amount ranging from about 3.0% to about 4% by weight based on the weight of the emulsified food product, the phosphoric acid is included in an amount ranging from about 0.1% to about 1% by weight based on the weight of the emulsified food product, and the lactic acid is included in an amount ranging from about 0.1% to about 1% by weight based on the weight of the emulsified food product. Specifically, the emulsified food product may include about 3.6% 120 grain vinegar, about 0.30% phosphoric acid, and about 0.30% lactic acid. The edible acid also enhances the flavors of the emulsified food product.

Preferably, at least one gum is included in the emulsified food product in an amount ranging from about 0.01% to about 0.5%, preferably about 0.1% to about 0.4%, and more preferably about 0.1% to about 0.3%. Suitable gums are selected from the group consisting of xanthan gum, guar gum, locust bean gum, gum arabic, propylene glycol alginates, carrageen, and combinations thereof. The gum functions as a thickening agent to help increase the product viscosity due to the reduction in the amount of oil. Xanthan gum is presently preferred.

Optionally, an emulsifier can be added to the emulsified food product in an amount ranging from about 0.01% to about 1.0% by weight based on the weight of the emulsified food product. In the preferred embodiment, the emulsifier is selected from the group consisting of polysorbate 60, soy lecithin, lecithin, agar, albumin, alginates, casein, glycerol monostearate, gums, Irish moss, and combinations thereof. Preferably, the emulsifier is polysorbate 60. The emulsified food product requires the mixture of oil and water, in particular, forming an oil in water emulsion. An emulsion is aided by use of various emulsifiers. Oil in water emulsions are best stabilized with emulsifiers that have a high degree of water solubility.

In one embodiment, the emulsified food product can also include at least one additive. The additive may be selected from the group consisting of colorants, herbs, spices, proteins, vegetables, flavorants, preservatives, flavor enhancers, and combinations thereof. The additives can be included in an amount of up to about 25% by weight based on the weight of the emulsified food product.

Herbs and/or spices can be added to the emulsified food product to augment and/or alter the flavor thereof. The herbs and/or spices can be selected from the group consisting of oregano, basil, parsley, chives, salt, pepper, mustard, coriander, curry, chili powder, close, lavender, rosemary, chervil, anise seed, garlic, cilantro, horseradish, fennel seed, bay leaves, caraway seeds, celery seed, allspice, nutmeg, paprika, thyme, tarragon, turmeric, dill, sage, saffron, poppy seed, sesame seed, marjoram, mint, cayenne pepper, mace, chipotle, cinnamon, fenugreek, ginger, garlic, wasabi, monosodium glutamate (MSG), and combinations thereof. The amount of herbs and/or spices added to the emulsified food product can depend on the strength of the flavor desired. The herbs and/or spices can be added as powders, granules, oils, whole leaves, leaf pieces, seeds, and combinations thereof.

Proteins can be added to flavor and/or add texture to the emulsified food product. The proteins can be added in small pieces and/or strips. The proteins may be vegetable protein such as soy or an animal protein, In some embodiments, the animal protein may be selected from the group consisting of fish, shellfish, beef, turkey, chicken, pork, lamb, bison, and combinations thereof. The proteins may be added to the emulsified food product in an amount sufficient to provide suitable flavor and/or texture to the emulsified food product.

Vegetables may also be added to flavor and/or add texture to the emulsified food product. The vegetables can be included as small pieces, flakes, powders, and/or purees. In some embodiments, vegetables can be selected from the group consisting of tomato, potato, carrot, turnip, spinach, lettuce, onion, pepper, celery, parsnip, asparagus, eggplant, bok choy, brussel sprouts, cabbage, corn, pumpkin, cucumber, squash, peas, beets, broccoli, and combinations thereof. The vegetables can be added as dried vegetable pieces, pickled vegetable pieces, such as relish, and/or fresh vegetable pieces. When used, the vegetables provide suitable flavor and/or texture to the emulsified food product.

Flavorants may also be added to alter and/or enhance the flavor of the emulsified food product. The flavorants can be incorporated as oils, encapsulated flavorants, powders, and combinations thereof. Preferred flavorants are selected from the group consisting of vegetable flavors, protein flavors, herb flavors, spice flavors, dairy flavors, and combinations thereof. The flavorants can be added in an amount sufficient to alter and/or enhance the flavor of the emulsified food product.

Preservatives may also be added to the emulsified food product to increase shelf life. Suitable preservatives are selected from the group consisting of potassium sorbate, ethylenediaminetetraacetic acid (EDTA), sodium benzoate, and combinations thereof. When included, the preservatives are added in an amount ranging from about 0.007% to about 0.2% by weight based on the weight of the emulsified food product. In the preferred embodiment, the emulsified food product includes EDTA, potassium sorbate, and sodium benzoate. The preservatives are added to inhibit growth of bacteria, yeast, and/or mold. In a preferred embodiment, the EDTA is added as a flavor protector. Disodium inosinate and disodium guanylate can also be included as flavor enhancers.

Once formed, the emulsified food product has at least about 10% less fat than a comparable regular fat food product, more preferably at least about 20% less fat. Also preferably, the emulsified food product has a similar mouth feel and taste to the comparable regular fat food product.

The following examples are exemplary and are not meant to limit any aspect of the embodiments disclosed herein.

### Example 1

An emulsified food product can include about 36% water, about 40% soybean oil, about 1.1% UltraSperse M®, about 1.9% enzyme modified egg yolk, about 0.30% phosphoric acid and about 0.30% lactic acid. In addition, the emulsified food product can include about 4.8% corn syrup, about 3.6% distilled 120 grain vinegar, about 3.5% fresh buttermilk, about 2.5% sugar, about 1.9% salted egg yolk, about 1.6% salt, 0.5% MSG, about 0.2% garlic, about 0.6% torula yeast, about 0.2% buttermilk flavor, about 0.2% xanthan gum, about 0.1% polysorbate 60, about 0.1% potassium sorbate, about 0.1% sodium benzoate, about 0.1% onion, 0.06% parsley, and about 0.01% disodium EDTA. The final composition has a pH ranging from about 3.2 to about 3.8.

### Example 2

An emulsified food product includes about 33% water, about 40% soybean oil, about 1.55% UltraSperse M® and Textra Plus®, about 0.30% phosphoric acid, and about 0.30% lactic acid. The final composition has a pH ranging from about 2.8 to about 3.8. In addition, the emulsified food product also includes about 4.8% corn syrup, about 3.6% distilled 120 grain vinegar, about 7.0% fresh buttermilk, about 2.5% sugar, about 1.9% salted egg yolk, about 1.6% salt, about 0.2% disodium inosinate and disodium guanylate, about 0.2% garlic, about 0.6% torula yeast, about 0.2% buttermilk flavor, about 0.2% xanthan gum, about 0.2% polysorbate 60, about 0.1% potassium sorbate, about 0.1% sodium benzoate, about 0.1% onion, about 0.1% parsley, and about 0.01% calcium disodium EDTA.

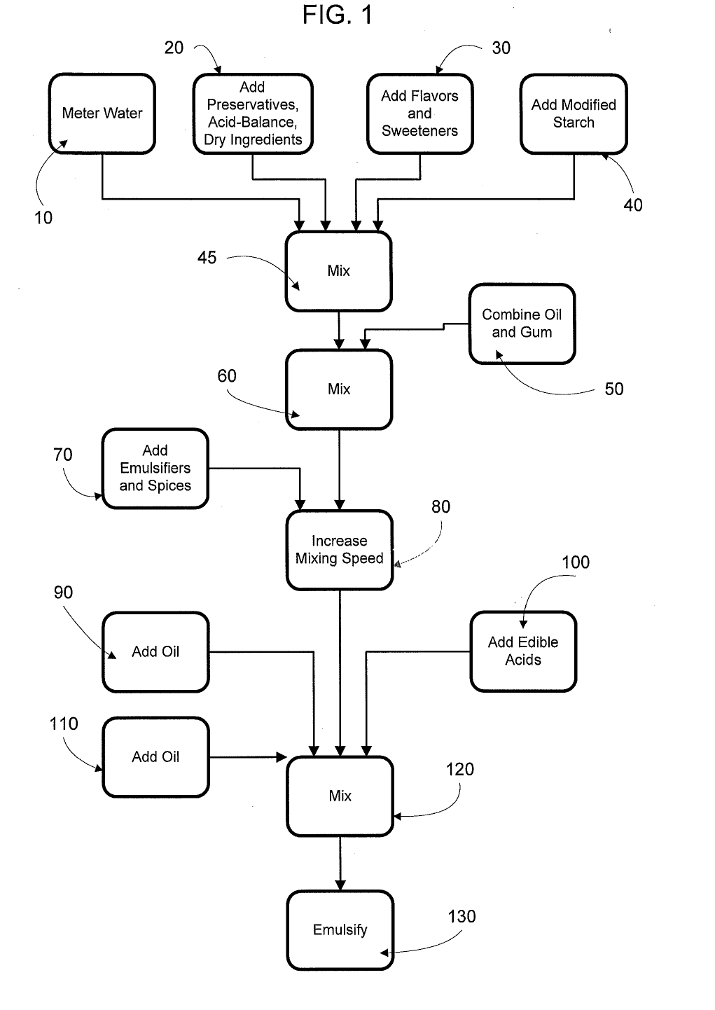

To make the emulsified food product, as shown in FIG. 1, cold water is metered into a mixer 10, which is set at an agitation setting of about 180 rpm. Full speed is about 300 rpm. The mixer is a “Dixie” style mixer with a “squirrel cage” agitator with variable speed adjustment. Preservatives, acid balancing flavor components, and other dry ingredients, such as herbs and spices or dairy powders, are then added to the water in the mixer and mixing 20 continues. The flavorants, sources of soluble fiber, and emulsifier are then added to the mixer while still mixing 30. Next, the modified starch is added and the mixture is mixed for an additional 2 to about 5 minutes, preferably about 2.5 minutes to about 3.5 minutes 40. In a separate sanitized container, about small amount of the oil and a gum, such as xanthan gum, are combined 50. The combined oil and gum are added to the mixer and mixed for about 5 minutes 60. The fresh dairy product, enzyme modified egg yolk, and salt are then added to the mixture 70 along with a flavor enhancer, such as MSG or disodium inosinate and disodium guanylate (I&G), and any other additives, such as additional herbs and spices, vegetable pieces and/or proteins. The mixer speed is then increased 80 to about 240 rpm. About 75% of the remaining oil is then added to the mixture 90 while mixing continues. Then, the edible acids are added 100 to the mixture. At this time, vegetable pieces and/or proteins could also be added, followed by the remaining oil 110. All ingredients are then mixed 120 for an additional minute or so and the mixer is turned off. Preferably, the mixture is combined and mixed at about 70° F. to about 80° F. The mixture is then processed 130 through a colloid mill. At this time, any other additives, such as additional herbs and spices, vegetable pieces, and/or proteins can be added. The food products is then filled, case packed, and shipped for consumer use.

The sequence of steps is important when making the emulsified food product. In an oil in water emulsion, the oil needs to be added to the water phase and not vice versa. Preservatives are added to the water first in order to dissolve them. Acidic ingredients should not be added right after the preservations to prevent the preservatives from flocculating out of solution. The dry ingredients are preferably added prior to thickening agents so that the dry ingredients will properly dissolve. Preservatives should be added early in the procedure to allow for proper dispersion and improved functionality. The starch is preferably added before the gum to allow for proper dispersion and hydration. The gum is pre-dissolved in oil to prevent gum balls from forming in the emulsion. Salt and egg yolks are added after gum dispersion and hydration to prevent inhibition of the functionality of the gum, which could result in lower viscosity of the finished product. The egg yolks are added prior to the oil to allow for proper dispersion and to provide the primary emulsifying agent before the oil in water emulsion begins to form. The oil is preferably split into two portions to allow for incorporation of acids and other components prior to the emulsion getting too thick. The acids are added before the remaining oil is added to allow for the formation of a stronger emulsion. If acids are added too early, the emulsion stability will be reduced.

### Example 3

To form a buttermilk ranch dressing, cold water in an amount of about 36% by weight of the total weight of the emulsified dressing is added to a mixer set at 180 rpm. About 0.1% potassium sorbate, about 0.1% sodium benzoate, about 0.007% EDTA, 0.6% yeast, about 0.2% garlic powder, about 0.035% shredded parsley, about 0.02% parsley granules, and about 0.1% onion powder are added to the water while mixing continues. About 0.15% buttermilk flavor, about 2.5% sugar, about 0.15% polysorbate 60, and about 4.8% corn syrup are then added to the mixer while mixing continues. About 1.1% modified starch is then added to the mixer, and the mixing continues for about 3 minutes. Separately, about 0.16% xanthan gum and a small amount of the soybean oil are combined. Then, the xanthan gum and soybean oil mixture is added to the mixer and mixing continues for about 5 more minutes. About 3.5% fresh buttermilk, about 1.9% egg yolk, about 1.9% enzyme modified egg yolk, about 1.62% salt, about 0.5% MSG, about 0.15% polysorbate 60, about 0.035% shredded parsley and about 0.02% parsley granules are added to the mixture. After the mixer speed is increased to about 240 rpm, about 75% of the remaining soybean oil is metered in. About 3.6% vinegar, about 0.3% phosphoric acid, and about 0.3% lactic acid are then added to the mixture. The remaining soybean oil is then metered into the mixer while mixing. Once the soybean oil is added, the mixture is mixed for an additional minute. The resulting dressing is then processed through a colloid mill and pumped into a clean container.

### Example 4

To form a tartar sauce, about 26% water by weight based on the weight of the tartar sauce is metered into a mixer. Preservatives including about 0.08% potassium sorbate, 0.075% sodium benzoate, and 0.075% calcium disodium EDTA are added to the water to form a mixture. Then, about 0.277% onion powder, about 0.128% garlic powder, about 3.75% sugar, about 0.1% mustard seed, and about 4.0% corn syrup are added to the mixture. About 1.05% modified starch is then added, and the mixture is mixed for an additional 3 minutes. Separately, about 0.16% xanthan gum and a small amount of the soybean oil (sauce includes 40% total) are combined, and then added to the mixer. The mixture is then mixed for an additional 5 minutes. About 1.5% salted egg yolk, about 1.5% enzyme modified egg yolk, and about 1.02% salt are added to the mixture. Then, about 75% of the remaining chilled soybean oil having a temperature of about 35° F. to about 50° F. is added to the mixture while mixing. While still mixing, about 6.67% distilled 120 grain vinegar, about 0.08% citric acid solution (including 50% citric acid and 50% water), and about 0.061% of an oil blend including about 82% soybean oil, about 1% Aquaresin dill weed Kalsec, and about 17% mustard oil solution are added to the mixture. The remaining chilled soybean oil is then added to the mixer, and the entire mixture is mixed for an additional minute. After pumping through a colloid mill at 0.025″ to about 0.035″ setting, about 19.5% dill relish is mixed into the sauce to form an emulsified tartar sauce.

The tartar sauce of Example 4 includes about 16% less fat than a conventional tartar sauce including about 50% soybean oil, about 12% water, about 5.8% 120 grain vinegar, about 3.5% salted egg yolk, about 20% dill relish, and about 8.5% other additives including preservatives, herbs, spices, and edible acids.

The emulsified food product as prepared herein can be packaged in individual packets, pouches, and the like, or can be packaged in large bottles and/or tubs. Moreover, the emulsified food product herein exhibits a shelf life that meets or exceeds the shelf life of products having much higher oil content. Some higher oil ranch dressings, for example, have a shelf-life of 120 days. When reformulated as an emulsified food product according to this disclosure, the reformulated product has been found to have a shelf-life of greater than 120 days.

The emulsified food product including enzyme modified egg yolk, acid balancing flavor component, corn syrup, and modified starch can be flavored to form various dressings, sauces, dips, and/or spreads including, without limitation, ranch dressing, bacon ranch dressing, thousand island dressing, Caesar dressing, creamy Italian dressing, tartar sauce, mayonnaise, and the like.

In a test comparing a regular ranch dressing and two samples of the emulsified ranch dressing as described herein, sixty consumer panelists evaluated the samples in individual tasting booths under white light using a personal computer to record their observations. The panelists rinsed between samples with room temperature filtered water, and cleansed their palates with plain saltine crackers. A 3-sample hedonic acceptance and ranking test was conducted to determine if a different acceptance existed between the samples. Samples were presented simultaneously to each panelist and served in a balanced, random order. Panelists evaluated the samples for overall liking and flavor liking using a standard 9-point hedonic scale anchored at each point with the following descriptors: (1) dislike extremely; (2) dislike very much; (3) dislike moderately; (4) dislike slightly; (5) neither like nor dislike; (6) like slightly; (7) like moderately; (8) like very much; and (9) like extremely. Panelists ranked the samples in order of preference. The hedonic data was analyzed using Analysis of Variance and Tukey's HSD post hoc mean comparison (Compusense five, version 4.6, Guelph, Canada). Ranking data was analyzed using Friedman Analysis of Rank and Tukey's HSD post hoc mean comparison. A significance level of alpha=0.05 was set. The overall liking an overall flavor liking scores for the control ranch and the two test ranch samples were not significantly different at the 95% significance level (n=60). Of the panelists, 42.7% preferred the second ranch sample, while 33.0% preferred the first ranch test sample, and only 25% preferred the original ranch sample.

In a second test, thirteen trained panelists with experience in profiling and prescreened for their sensory acuity evaluated ranch dressing samples for key attributes using an applicable subset of the ranch dressing language taken from the Sense-It language. Panelists individually rated the intensity of the attributes using a 100 point scale. The group ranges were discussed and mean scores were depicted graphically. Significant differences were determined using an Analysis of Variance and T-test (p</=0.05). The 100 point scale is as follows: 0=none, 10-20=low, 20-40=low-medium, 40-60=medium, 60-80=medium-high and 80-100=high. Three samples including a control sample of regular fat ranch and two samples of the ranch dressing as formed herein were presented monadically. One each of the test and control sample was served in a cup labeled with a 3-digit code. The panelists rated the samples based on the descriptors detailed in Table 1 below.

TABLE 1

| Descriptor | |
|---|---|
| Name | Descriptor Definition |
| Buttermilk | The flavor associated with cultured buttermilk |
| Creamy-Sour | Dairy note associated with sour cream, butter and yogurt |
| Dill | Green, herbaceous, spicy, peppery, and caraway-like |
| | aromatic characteristic of ground dill seed |
| Eggy | Aroma associated with cooked egg |
| Fishy | Aromatic associated with irritating sharp sensation of old, |
| | decaying fish |
| Onion | The flavor associated with onion powder |
| Black Pepper | Pungent, spicy, camphoraceous and musty aromatic |
| | associated with fresh ground black peppercorns |
| Garlic | Pungent, woody, green and alliaceous aromatic associated |
| | with garlic |

The samples were also rated for overall intensity, salty notes, sour notes, and sweet notes. Of the 12 sensory terms used to describe the ranch dressing, eight were found to be statistically significant including overall intensity, sour, sweet, buttermilk, eggy, dill, fishy, and black pepper. The control ranch was rated significantly higher in intensity for overall intensity, sour, and buttermilk, while the test ranch samples were rated significantly higher in intensity for sweet, eggy, dill, fishy, and black pepper.

Yet another test compared texture attributes of emulsified food products according this specification with the same texture attributes of a commercially available ranch salad dressing and resulted in unexpectedly close parity in the test results. For purposes of the test, a commercially available ranch dressing was used as the control. The control was a PPI Ranch Dressing for which the significant characteristics were 57% soybean oil, no starch, and no enzyme modified egg yolk. “Test 1” was a ranch dressing according to the present specification for which the significant characteristics were 40% soybean oil (a 30% reduction over the control ranch dressing), 0.80% UltraSperse M modified starch, and enzyme-modified egg yolk. “Test 2” was a ranch dressing according to the present specification for which the significant characteristics were 40% soybean oil (a 30% reduction over the control ranch dressing), 0.75% UltraSperse M modified starch, 0.75% Textra Plus modified starch, and enzyme modified egg yolk. Thus, both of the test dressings exhibited a 30% reduction in calories from fat.

For testing purposes, the control dressing, as well as the Test 1 and Test 2 dressings were served at refrigeration temperature, about 40° F. Panelists trained in Sensory Spectrum methodology of foods evaluated the three products. Products were provided to the panelists using a randomized Williams Latin Square design. The panelists evaluated the texture and mouthfeel of the three products using the following texture attributes:

Texture Attributes

| | |
|---|---|
| 1. | Surface Shine (in container) |
| 2. | Viscosity (Stir) |
| 3. | Rate of Flow |
| 4. | Stringiness |
| 5. | Elasticity |
| 6. | Viscosity (Oral) |
| 7. | Cohesiveness |
| 8. | Evenness of Mouthcoating |
| 9. | Slipperiness |
| 10. | Gritty (Oral) |
| 11. | Chalky/Powdery (Oral) |
| 12. | Mixes with Saliva |
| 13. | Rate of Breakdown |
| 14. | Total Residual Mouthcoating |
| 15. | Residual Dairy Mouthcoating |
| 16. | Residual Chalky/Powdery Mouthcoating |
| 17. | Residual Oily Mouthcoating |
| 18. | Mouthdrying |

The panelists rated the intensity of the foregoing texture attributes against a 15-point scale using references that were provided. Small spoons were used to evaluate oral texture attributes, while large spoons were used to evaluate appearance attributes.

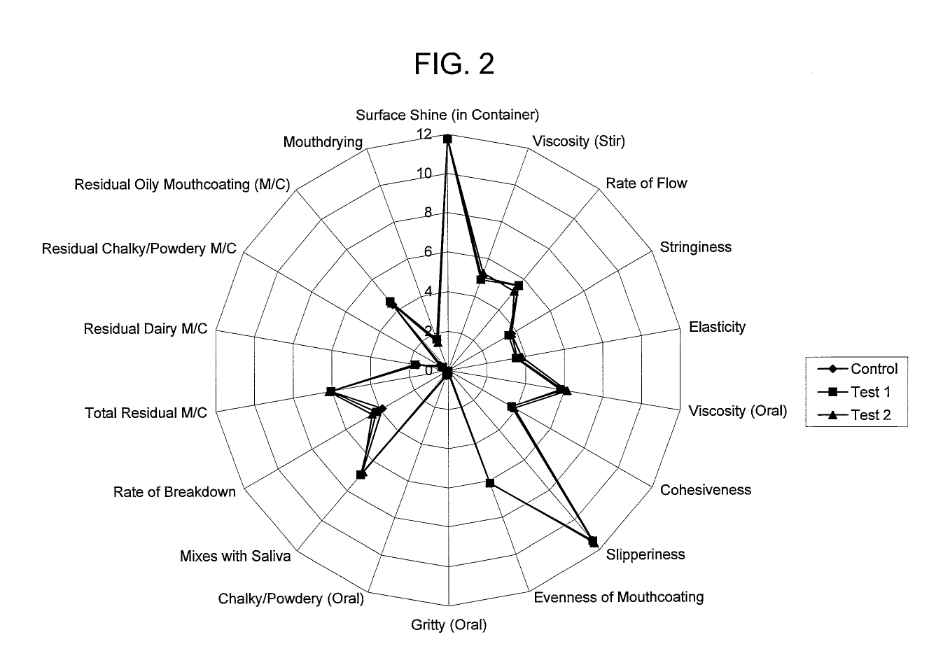

Resulting panelist data for the three products were analyzed using a standard analysis of variance (ANOVA) statistical technique along with testing for significant differences using a standard Fisher's least significant differences (LSD) statistical analysis technique. The test results for the three products are shown in FIG. 2 in a radar or spider plot to give a visual comparison of the texture attributes for the three products.

The degree of congruency of the spider plots in FIG. 2 for the control and the two test products is unexpected and striking, especially because the oil content of the test products is 30% less than the oil content of the control. Similar results are expected for other reduced oil content formulations of emulsified food products according to this specification. The very similar texture attributes for the control and the test products according to this invention indicates that the fat mimetic starches in combination with the enzyme-modified egg yolk are effective to compensate for the reduction in oil and provide the same texture and mouthfeel to the consumer.

In this specification, the word “about” is often used in connection with numerical values to indicate that mathematical precision of such values is not intended. Accordingly, it is intended that where “about” is used with a numerical value, a tolerance of ±10% is contemplated for that numerical value.

While the foregoing describes in detail a preferred an emulsified product and a method of making that product with reference to a specific embodiment thereof, it will be apparent to one skilled in the art that various changes and modifications may be made to the emulsified product and equivalent method steps may be employed, which do not materially depart from the spirit and scope of the emulsified product described herein. Accordingly, all such changes, modifications, and equivalents that fall within the spirit and scope of the emulsified product as defined by the appended claims are intended to be encompassed thereby.

We claim:

1. A food product comprising:
about 0.1% to about 5.5% enzyme modified egg yolk;
about 0.1% to about 5.0% modified starch;
about 0.1% to about 0.6% acid balancing flavor component, said acid balancing flavor component selected from the group consisting of sugar, yeast, and combinations thereof; and
corn syrup.

2. The food product of claim 1 further including,
water; and
vegetable oil in an amount of about 30% to about 45% by weight based on the weight of the food product.

3. The food product of claim 1, wherein the food product has a pH of about 2.8 to about 4.1.

4. The food product of claim 1, wherein the vegetable oil is soybean oil.

5. The food product of claim 1, further including at least one optional additive selected from the group consisting of spices, herbs, vegetables, proteins, flavors, colors, preservatives, flavor enhancers, and combinations thereof.

6. The food product of claim 2, having a fat content reduced by at least about 10% as compared to a conventional emulsified food product.

7. The food product of claim 1, further including at least one dairy product.

8. The food product of claim 7, wherein the at least one dairy product is buttermilk.

9. The food product of claim 1, wherein the modified starch is an instant, cold-water swelling starch.

10. The food product of claim 1, further including water in an amount of about 30% to about 45% by weight based on the weight of the food product.

11. The food product of claim 1, wherein the food product includes about 36% water, about 40% soybean oil, about 1.1% modified starch, about 1.9% enzyme modified egg yolk, about 0.6% acid balancing flavor component, about 4.8% corn syrup, and about 15.6% additives.

12. The food product of claim 1, wherein the yeast is a torula yeast.

13. The food product of claim 1, further including at least one edible acid.

14. The food product of claim 13, wherein the at least one edible acid is selected from the group consisting of phosphoric acid, lactic acid, citric acid, vinegar, and combinations thereof.

15. The food product of claim 1, wherein the food product is selected from the group consisting of dips, spreads, dressings, sauces, and combinations thereof.

16. A method of making an food product comprising the steps of:
providing (a) an enzyme modified egg yolk in an amount of about 0.1% to about 5.5% by weight based on the weight of the emulsified food product, (b) at least one modified starch in an amount of about 0.1% to about 5.0% by weight based on the weight of the food product, (c) at least one acid balancing flavor component in an amount of about 0.1% to about 0.6% by weight based on the weight of the food product, (d) corn syrup, (e) water, and (f) oil; and
mixing the enzyme modified egg yolk, the at least one modified starch, the at least one acid balancing flavor component, the corn syrup, the water, and the oil to form the food product.

17. The method of claim 15, further including adding preservatives, acid balancing flavor components, edible acids, sources of soluble fiber, and optional additives to the mixture during the mixing step.

18. The method of claim 15, further including separately combining oil and gum and then adding the combined oil and gum to the mixture during the mixing step.

19. The emulsified food product of claim 15, wherein the water is chilled to less than about 80° F.

20. A food product comprising:
about 0.1% to about 5.5% enzyme modified egg yolk;
about 0.1% to about 5.0% modified starch;
about 0.1% to about 0.6% acid balancing flavor component, said acid balancing flavor component selected from the group consisting of sugar, yeast, and combinations thereof; and
a sweetener.

21. A method of making an food product comprising the steps of:
providing (a) an enzyme modified egg yolk in an amount of about 0.1% to about 5.5% by weight based on the weight of the emulsified food product, (b) at least one modified starch in an amount of about 0.1% to about 5.0% by weight based on the weight of the food product, (c) at least one acid balancing flavor component in an amount of about 0.1% to about 0.6% by weight based on the weight of the food product, (d) a sweetener, (e) water, and (f) oil; and
mixing the enzyme modified egg yolk, the at least one modified starch, the at least one acid balancing flavor component, the sweetener, the water, and the oil to form the food product.
